(19) United States
(12) Patent Application Publication
(10) Pub. No.: US 2007/0008477 A1
(43) Pub. Date: Jan. 11, 2007

(54) Display module

(75) Inventor: Jih-Fon Huang, Hsinchu (TW)

Correspondence Address: BIRCH STEWART KOLASCH & BIRCH, PO BOX 747, FALLS CHURCH, VA, 22040-0747, US

(73) Assignee: Industrial Technology Research Institute

(21) Appl. No.: 11/398,521

(22) Filed: Apr. 6, 2006

(30) Foreign Application Priority Data
Jul. 8, 2005 (TW) 094123114

(51) Int. Cl. G02F 1/1345

(52) U.S. Cl. 349/149

(57) ABSTRACT

A display module includes a display panel having a substrate as a base at least provided with conductive circuits and external connection pins; and a circuit board electrically connected with the external connection pins of the substrate through a conductive material for driving the display panel. The substrate could be electrically connected with the circuit board without the need of flexible printed circuit boards, thereby simplifying structure of the display module.

### FIELD OF THE INVENTION

The present invention relates to a display and more particularly relates to a display module to be applied to a display.

### BACKGROUND OF THE INVENTION

With improvement of the life quality and increasing demands for wireless and portable products capable of displaying images, image displaying products such as displays characterized with light weight, damaging resistance, high image quality, low electricity consumption and low price have become the research focus.

Today's displays with TFT-LCD modules (thin film transistor liquid crystal display module) are divided into two kinds: TAB TFT-LCD and COG TFT-LCD. FIG. 1A shows a TAB TFT-LCD module 100 and FIG. 1B shows a COG TFT-LCD module 200. Display panels of the display modules 100, 200 respectively have substrates 101, 201 formed of glass. The TAB TFT-LCD module 100 uses eight flexible printed circuit boards to connect the glass substrate 101 with a printed circuit board 105. On the other hand, the COG TFT-LCD module 200 uses five flexible printed circuit boards to connect the glass substrate 201 with a printed circuit board 205.

FIGS. 2A to 2C are diagrams showing a process using an anisotropic conductive film to electrically connect the glass substrate with a flexible printed circuit board in a TAB TFT-LCD module 100. First, as shown in FIG. 2A, an anisotropic conductive film 107 is attached to the glass substrate 101; next, as shown in FIG. 2B, a flexible printed circuit board 102 is pre-bonded to one surface of the glass substrate 101 having the anisotropic conductive film 107; then, as shown in FIG. 2C, a high temperature and high pressure process is conducted to main-bond the flexible printed circuit board 103 to the glass substrate 101. Further, as shown in FIG. 3A, an anisotropic conductive film 107 is attached to a printed circuit board 105; then as shown in FIG. 3B, the flexible printed circuit board 103 having been bonded to the glass substrate 101 is pre-bonded to surface of the printed circuit board 105 having the anisotropic conductive film 107; next, as shown in FIG. 3C, a high temperature and high pressure process is conducted to main-bond the flexible printed circuit board 103 to the printed circuit board 105. As a result, the printed circuit board 105 is electrically connected to the glass substrate 101 through the flexible printed circuit board 103.

Referring to FIG. 4A, the flexible printed circuit board 103 electrically connects the printed circuit board 105 and IC 109 disposed on the printed circuit board 105 to the glass substrate 101. Or as shown in FIG. 4B, the flexible printed circuit board 103 connects the printed circuit board 105 to the glass substrate 101 and IC 109 is disposed on the flexible printed circuit board 103. Or as shown in FIG. 4C, the flexible printed circuit board 103 connects the printed circuit board 105 to the glass substrate 101 and IC 109 is disposed on the glass substrate 101.

Further, as shown in FIG. 5A, the flexible printed circuit board 103 connected to the glass substrate 101 through the anisotropic conductive film 107 is easy to crack at the connecting position. Therefore, as shown in FIGS. 5B or 5C, it is necessary to dispose an adhesive portion 1031 at connecting edges between the glass substrate 101 and the flexible printed circuit board 103 for closely bonding the glass substrate 101 with the flexible printed circuit board 103 and increasing stress resistant intensity of the flexible printed circuit board 103.

However, such glass material limits application fields of the glass substrate 101. For example, to produce large sized products having large sized glass substrate, the glass substrate is heavy and easy to crack, resulting in higher production cost and lower yield rate. Moreover, the glass substrate makes the final products much complex and thick. In addition, it is hard to produce the glass substrate as a bendable structure. As a result, the glass substrate could not meet requirement of the lighter and thinner displays of the new age.

Meanwhile, in the prior art, the printed circuit board 105 is electrically connected to the glass substrate 101 through multiple sheet flexible printed circuit boards 103, which results in higher cost and makes the manufacturing process complex.

In addition, as shown in FIG. 6, signal from a device 10 needs to pass through the conductive circuits 1011 of the glass substrate 101, the anisotropic conductive film 107 disposed between the glass substrate 101 and the flexible printed circuit board 103, the conductive circuits 1031 of the flexible printed circuit board 103, the anisotropic conductive film 107 disposed between the flexible printed circuit board 103 and the printed circuit board 105, the conductive circuit 1051 of the printed circuit board 105 before finally arriving to the IC 109, that is R=R_{tft}+R_{acf1}+R_{fpc+}R_{acf2}+R_{PCB}. As a result, higher voltage or current is required for signal transferring. Also, electrical performance is deteriorated because of too much transferring interfaces.

### SUMMARY OF THE INVENTION

To overcome the above-mentioned problems of the prior art, the primary objective of the present invention is to provide a display module with simplified structure.

Another objective of the present invention is to provide a display module with simplified manufacturing process.

Another objective of the present invention is to provide a display module with lower manufacturing cost.

Another objective of the present invention is to provide a light-weight display module.

A further objective of the present invention is to provide a display module with improved electrical performance.

To achieve the above and other objectives, the present invention provides a display module including a display panel having a substrate as a base at least provided with conductive circuits and external connection pins; and a circuit board electrically connected with the external connection pins of the substrate through a conductive material for driving the display panel.

The display panel is a liquid crystal panel or an organic light-emitting diode panel and preferably, the liquid crystal panel is a TFT (thin film transistor) liquid crystal panel.

The display panel further includes at least one upper panel that is combined with the substrate. Preferably, the upper panel is a color filter or a protective plate. The conductive material film could be one of the group consisting of TCF, NCF or anisotropic conductive film.

The substrate is a plastic substrate or a metallic substrate. Preferably, the plastic substrate is one selected from the group consisting of PES (polyether sulfone), PET (polyethylene terephthalate), PAR (polyarylate), COC (cyclic olefin copolymer) and PC (polycarbonate); the metallic substrate is one selected from the group consisting of pure Ti, Pure Al, Ti alloy, Ti—Mo alloy, Al alloy stainless and Al—Mg alloy.

The above conductive circuits could be formed of conductive traces. Preferably, each of the external connection pins extending from the conductive circuits could be one selected from the group consisting of a pad, a finger and a golden finger.

A bending structure is disposed at one side of the substrate corresponding to the conductive circuits. Preferably, the bending structure includes two unfilled corners disposed at two sides of the conductive circuits on the substrate; alternatively, the bending structure includes an impression disposed on surface of the substrate.

Moreover, conductive circuits are disposed at adjacent sides on the substrate and a cut is formed at corner between the conductive circuits provided at the adjacent sides on the substrate. Preferably, the cut is obliquely formed at the corner between the conductive circuits provided at the adjacent sides on the substrate. The cut could be in an L-shape or an arc shape. Moreover, the cut could be transversely disposed at one side of the substrate and parallel to the conductive circuits at the said side.

The display module mentioned above further includes a positioning structure for providing a positioning relationship between the substrate and the circuit board. Preferably, the positioning structure includes marks and positioning holes; the marks could be disposed on the surface of the substrate and the positioning holes could be disposed at the corresponding position on surface of the circuit board. Moreover, the positioning structure could include conductive circuits disposed on top surface of the circuit board, pins disposed on top surface of the circuit board or marks disposed on top surface of the circuit board and corresponding to both edges of the substrate. Shape of the marks could be one of the group consisting of a straight line, a cross shape and an L-shape.

The display module of the present invention uses a plastic substrate or a metallic substrate as a base of a display panel and the substrate is electrically connected with a circuit board through a conductive material without the need of flexible printed circuit boards, thereby simplifying structure of the display module and relatively simplifying the manufacturing process, reducing manufacturing cost and weight. In addition, avoiding the use of flexible printed circuit boards reduces interfaces during signal transferring, thereby enhancing electrical performance. Accordingly, the display module could be applied to a flexible display.

Other aspects and features will become apparent to those ordinarily skilled in the art upon review of the following description of the preferred embodiments of the present invention in conjunction with the accompanying drawings.

### DESCRIPTION OF THE PREFERRED EMBODIMENTS

As shown in FIG. 7A, the present invention provides a display module 300, which could be applied to a TFT-LCD, for example. The display module 300 includes a display panel and a circuit board 305. The display panel at least comprises a substrate 301 and an upper panel 303, the substrate 301 and the upper panel 303 being combined together. As the present embodiment refers to a TFT display panel, the substrate 301 functions as a base of the display panel and the upper panel 303 could be a color filter. In addition, the display panel could be sandwiched by not-shown polarizing films. The circuit board 305 could be a liquid crystal driver for driving the display panel. The circuit board 305 has an IC 307. The circuit board 305 and the substrate 301 are electrically connected through an anisotropic conductive film 302. Although the present embodiment describes a TFT display panel, it should be understood that an OLED (Organic Light Emitting Diode) display panel could be adopted alternatively. Correspondingly, the upper panel 303 should be changed from a color filter to a protective plate.

The substrate 301 could be a plastic substrate formed from one of the group consisting of PES (polyether sulfone), PET (polyethylene terephthalate), PAR (polyarylate), COC (cyclic olefin copolymer) and PC (polycarbonate). Alternatively, the substrate 301 could be a metallic substrate formed from one of the group consisting of pure Ti, Ti alloy, Ti—Mo alloy, Al alloy stainless and Al—Mg alloy.

As shown in FIG. 8A, on top surface of the substrate 301 there disposed conductive circuits 3011 formed of conductive traces and external connection pins 3013 extended from the conductive circuits 3011 at one side of the substrate 301. In the present embodiment, each of the pins 3013 is a finger. Similarly, on bottom surface of the circuit board 305 there disposed conductive circuits 3051 formed of conductive traces and external connection pins 3053 extended from the conductive circuits 3051 at one side of the circuit board 305. In the present embodiment, each of the pins 3051 is also a finger. The pins 3013 of the substrate 301 and the pins 3053 of the circuit board 305 are electrically connected through an anisotropic conductive film 302 by conducting a high temperature and high pressure process, wherein the anisotropic conductive film 302 has been pre-attached to either the substrate 301 or the circuit board 305. Because the present invention avoids using a flexible printed circuit board as an interface, structure of the display module 300 is simplified, thereby reducing weight of the display module 300. Further, the whole processing of the display module 300 is simplified, thereby reducing manufacturing cost. Accordingly, the display module could be applied to a flexible display. Although the present invention adopts the anisotropic conductive film 302 as electrical connection between the pins 3013 and 3053 which are formed of fingers, it is not limited thereto. Alternatively, the pins 3013, 3053 could be formed of pads or conductive bumps. Electrical connection between the pins 3013 and 3053 could be implemented by solder technique, which is a prior art and detailed description of which is omitted.

As shown in FIG. 8B, to prevent the conductive circuits from being eroded, a glue layer 309 is formed to cover the electrical connecting area, thereby strengthening connection between the substrate 301 and the circuit board 305 and enhancing stress intensity of the substrate 301. In addition, the glue layer 309 could keep the electrical connecting area from being scratched and make the electrical connecting area dustproof and shock-resistant.

FIGS. 7B to 7E show other possible structures of the display module. Structure of the display module in FIG. 7B is similar to that in FIG. 7A. The main difference of FIG. 7B from FIG. 7A is that the IC 307 is disposed on the substrate 301 instead of the circuit board 305. Referring to FIG. 7C, the substrate 301 and the circuit board 305 are electrically connected through a connector 3055 pre-disposed on the circuit board 305 and each of the pins 3013 of the substrate 301 is designed as a golden finger for making plug easier. In addition, this structure avoids soldering process. FIG. 7D shows a structure of a display module similar to that in FIG. 7C. The main difference of FIG. 7D from FIG. 7C is that the IC 307 is disposed on the substrate 301. FIG. 7E shows a structure of a display module similar to that in FIG. 7D. The main difference of FIG. 7E from FIG. 7D is that the circuit board 305 is disposed upside-down.

Moreover, as shown in FIG. 9, a signal of a device 30 in the display panel only needs to pass through the conductive circuits 3011 of the substrate 301, the anisotropic conductive film 302 disposed between the substrate 301 and the circuit board 305, and the conductive circuits 3051 of the circuit board 305 before finally arriving to the IC 307, that is, R=R_{tft}+R_{acf}+R_{PCB}. Compared with the prior art that uses a flexible printed circuit board and two anisotropic conductive films as signal transferring interfaces, the present invention avoids the use of the flexible printed circuit board and one of the anisotropic conductive films, thereby shortening the signal transferring path and accordingly improving electrical performance of the display module. Particularly, because R_{acf} is usually much larger than R_{PCB} and R_{tft}, reducing one of the anisotropic conductive films in the present invention means that nearly half of R is reduced, thereby greatly improving electrical performance of the display module.

FIGS. 10A to 10H are diagrams showing seven kinds of bending structures of a display panel of the present invention. As shown in FIG. 10A, the conductive circuits 3011 formed of conductive traces are disposed at least at one side of the top surface of the substrate 301 and the external connection pins 3013 extending from the conductive circuits 3011 are formed at one side of the substrate 301. The substrate 301 could be formed of plastic material. The upper panel 303 could be formed of plastic material or glass material. The upper panel 303 formed of glass material is scratch-resistant and could be adsorbed by a vacuum slot during a soldering process. Moreover, although the plastic or metallic sheet substrate 301 is bendable, the following bending structure design will enhance the bendable feature of the substrate.

As shown in FIG. 10B, two unfilled corners 3014 are formed at two sides of the conductive circuits 3011 such that width of the substrate 301 corresponding to the conductive circuits 3011 is reduced, thereby providing much easily bendable structure.

As shown in FIG. 10C, an impression 3015 is transversely disposed between the conductive circuits 3011 and the upper panel 303 on the substrate 301 for relatively decreasing structure intensity at this position, thereby providing much easily bendable structure.

As shown in FIG. 10D, conductive circuits 3011 and corresponding external connection pins 3013 are disposed at two adjacent sides on top surface of the substrate 301 and a cut 3016 is obliquely formed at the corner between the conductive circuits 3011 provided at the two adjacent sides on the substrate 301 for decreasing width of the substrate 301 corresponding to each conductive circuits 3011, thereby providing much easily bendable structure.

As shown in FIG. 10E, conductive circuits 3011 and corresponding external connection pins 3013 are disposed at two adjacent sides on top surface of the substrate 301 and unfilled corners 3014 are formed at two sides of each of the conductive circuits 3011 to decrease width of the substrate 301 corresponding to each conductive circuit 3011, thereby providing much easily bendable structure.

As shown in FIGS. 10F to 10H, conductive circuits 3011 and corresponding external connection pins 3013 are disposed at two adjacent sides on top surface of the substrate 301 and cuts 3017, 3018, 3019 of different shapes are respectively formed at different positions on the substrate 301 between the conductive circuits 3011 provided at the two adjacent sides. As shown in FIG. 10F, the cut 3017 is transversely disposed at one side of the substrate 301 and parallel to the conductive circuit 3011 at said side of the substrate 301. As shown in FIG. 10G, the cut 3018 of an L-shape is disposed at the corner between the conductive circuits 3011 provided at the two adjacent sides. As shown in FIG. 10H, the cut 3019 of an arc shape is disposed at the corner between the conductive circuits 3011 provided at the two adjacent sides of the substrate. The cuts 3017, 3018 and 3019 respectively forms a bending structure to decrease width of the connection part between the conductive circuits 3011 and the substrate 301, thereby providing much easily bendable structure.

Based on the above bending structures, the display module of the present invention could be applied to a product having multiple sheet display panels. As shown in FIGS. 1A and 1B, a display module having multiple sheet display panels includes a display panel and a circuit board 305. The display panel at least comprises a sheet substrate 301 and two sheet upper panels 303, the substrate 301 being respectively combined with the upper panels 303. The circuit board 305 is electrically connected with the pins 3013 disposed on the substrate 301 through an anisotropic conductive film 302. The substrate 301 could be formed of plastic material. A bending structure such as unfilled corners is formed between the two sheet upper panels 303 for reducing width of the connection part, thereby providing much easily bendable structure. It should be noted that size of the substrate 301 could be increased to accommodate much more upper panels 303. In addition, other bending structure such as impressions or notches could be adopted.

As mentioned above, the conductive circuits 3011 formed of conductive traces are disposed on top surface of the substrate 301. The conductive circuits 3051 formed of conductive traces are disposed on bottom surface of the circuit board 305 and electrically connected with the corresponding conductive circuits 3011 through an anisotropic conductive film 302 pre-attached to either side by conducting a high temperature and high pressure process. To provide exact position relationship for electrical connection, a position structure could further be used as shown in FIGS. 12A to 12E.

As shown in FIG. 12A, cross marks 40 are disposed at two sides of the conductive circuits 3011 on top surface of the substrate 301 and positioning holes 41 are formed at positions corresponding to the marks 40 on the circuit board 305. When covering the substrate 301 with the circuit board 305 for electrical connection, the positioning structure consisting of the marks 40 and the positioning holes 41 makes it possible to correctly identify positions up and down by using an automatic device such as sensor, thereby correctly aligning the conductive circuits 3051 on the bottom surface of the circuit board 305 with the conductive circuits 3011 on the top surface of the substrate 301.

As shown in FIG. 12B, positioning holes 41 are disposed at two sides of the conductive circuits 3011 on top surface of the substrate 301. The cross marks 40 are formed at positions corresponding to the positioning holes 41 on the circuit board 305 and the corresponding conductive circuits 3051 are disposed on both top and bottom surfaces of the circuit board 305. When covering the substrate 301 with the circuit board 305 for electrical connection, the positioning structure consisting of the marks 40 and the positioning holes 41 makes it possible to correctly identify positions up and down by using an automatic device such as electric eye, thereby correctly aligning the conductive circuits 3051 on the top surface of the circuit board 305 with the conductive circuits 3011 on the top surface of the substrate 301. Accordingly, the conductive circuits 3051 on the bottom surface of the circuit board 305 are aligned with the conductive circuits 3011 on the top surface of the substrate 301.

As shown in FIG. 12C, on top surface of the substrate 301 there disposed conductive circuits 3011 such as conductive traces and external connection pins 3013 extending from the conductive circuits 3011 at one side of the substrate. On bottom surface of the circuit board 305 there disposed conductive circuits 3051 and pins 3053. In addition, pins 3053 are also correspondingly disposed on top surface of the circuit board 305. When covering the substrate 301 with the circuit board 305 for electrical connection, the positioning structure consisting of the pins 3053 disposed on the top surface of the circuit board 305 makes it possible to correctly identify positions up and down by using an automatic device such as electric eye, thereby correctly aligning the pins 3053 on the top surface of the circuit board 305 with the conductive circuits 3011 on the top surface of the substrate 301. Accordingly, the pins 3053 on the bottom surface of the circuit board 305 are aligned with the pins 3013 on the top surface of the substrate 301. Moreover, a simplified positioning structure could be adopted by disposing only two pins 3053 at two outermost sides on top surface of the circuit board 305, as shown in FIG. 12D.

As shown in FIG. 12E, marks 42 are disposed corresponding to two edges of the substrate 301 on top surface of the circuit board 305 and shape of the marks 42 could be a straight line, a cross shapes or an L-shape. When covering the substrate 301 with the circuit board 305 for electrical connection, the positioning structure consisting of the marks 42 makes it possible to correctly identify positions up and down by using an automatic device such as electric eye, thereby correctly aligning the marks 42 with the two edges of the substrate 301.

According to the present invention, a plastic substrate or metallic substrate used as a base of a display panel is electrically connected with a circuit board without the need of flexible printed circuit boards. As a result, the display module could have a simplified and light-weight structure and it could be manufactured by more simple process with lower cost. Moreover, avoiding the use of flexible printed circuit boards reduces connection interfaces in signal transferring path, thereby enhancing electrical performance. Further, such a display module could be applied to a flexible display.

Although the present invention has been described in accordance with the embodiments shown, it would be appreciated by those skilled in the art that changes may be made without departing from the sprit and principles of the present invention.

### BRIEF DESCRIPTION OF THE DRAWINGS

FIG. 1A is a diagram showing a TAB TFT-LCD module of the prior art;

FIG. 1B is a diagram showing a COG TFT-LCD module of the prior art;

FIGS. 2A to 2C are diagrams showing a process for electrically connecting a glass substrate with a flexible printed circuit board through an anisotropic conductive film in a TFT-LCD module of the prior art;

FIGS. 3A to 3C are diagrams showing a process for electrically connecting a glass substrate with a circuit board through a flexible printed circuit board and anisotropic conductive films in a TFT-LCD module of the prior art;

FIGS. 4A to 4C are diagrams showing three kinds of structures of a TFT-LCD module of the prior art;

FIGS. 5A to 5C are diagrams showing a process of disposing an adhesive portion for preventing cracks of the flexible printed circuit board in a TFT-LCD module of the prior art;

FIG. 6 is a diagram showing a signal transferring path in a TFT-LCD module of the prior art;

FIGS. 7A to 7E are diagrams showing five kinds of structures of a display module of the present invention;

FIG. 8A is a diagram showing a partial structure of the display module in FIG. 7A;

FIG. 8B is a diagram showing a partial structure of the display module according to a preferred embodiment of the present invention;

FIG. 9 is a diagram showing a signal transferring path of the display module of the present invention;

FIGS. 10A to 10H are diagrams showing seven kinds of bending structures of a display panel of the present invention;

FIG. 11A is a diagram showing a structure of a display module having multiple display panels of the present invention;

FIG. 11B is a side view of the display module structure in FIG. 11A at a bending state; and

FIGS. 12A to 12E are diagrams of five kinds of positioning structures of a display panel of the present invention.

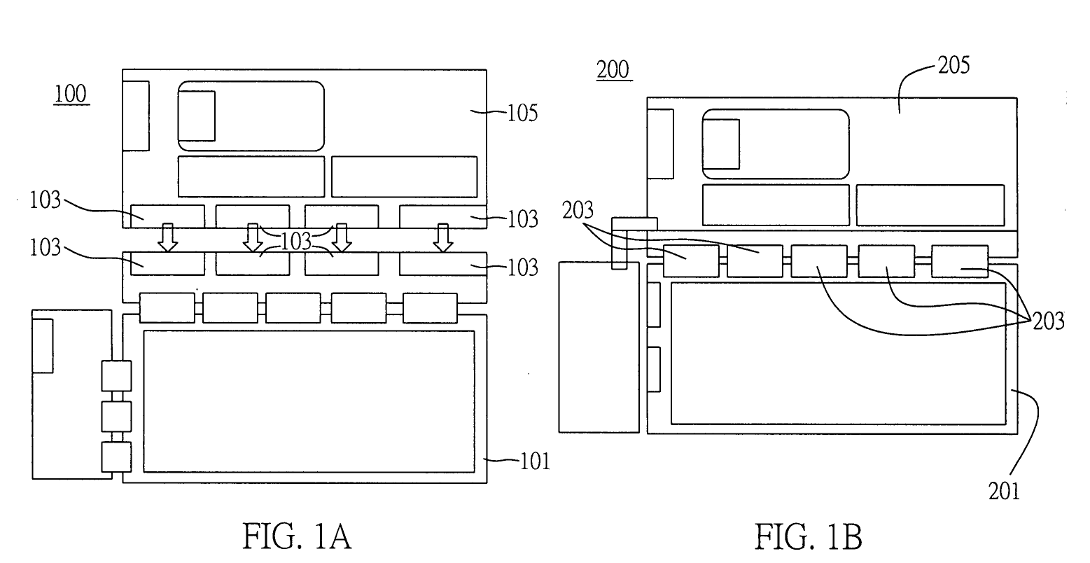

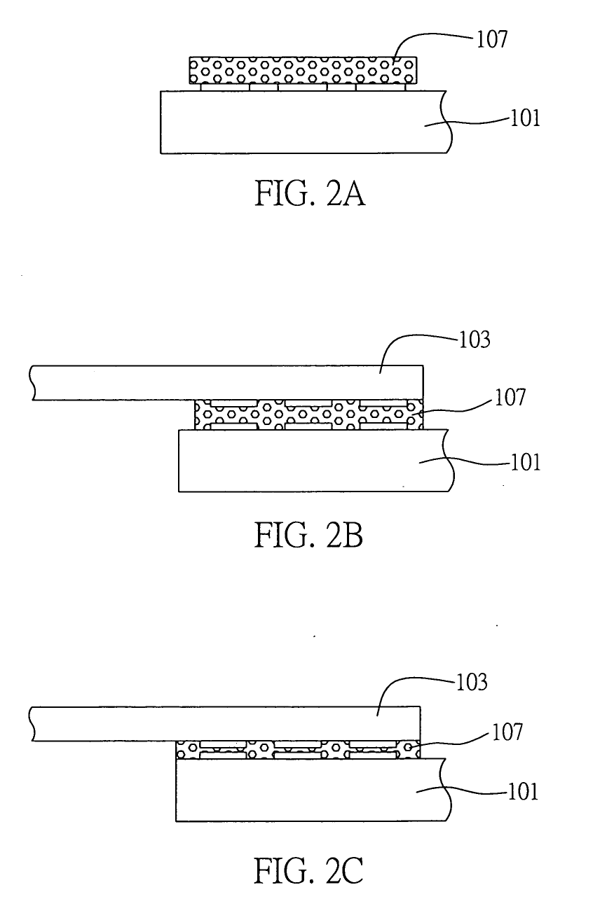

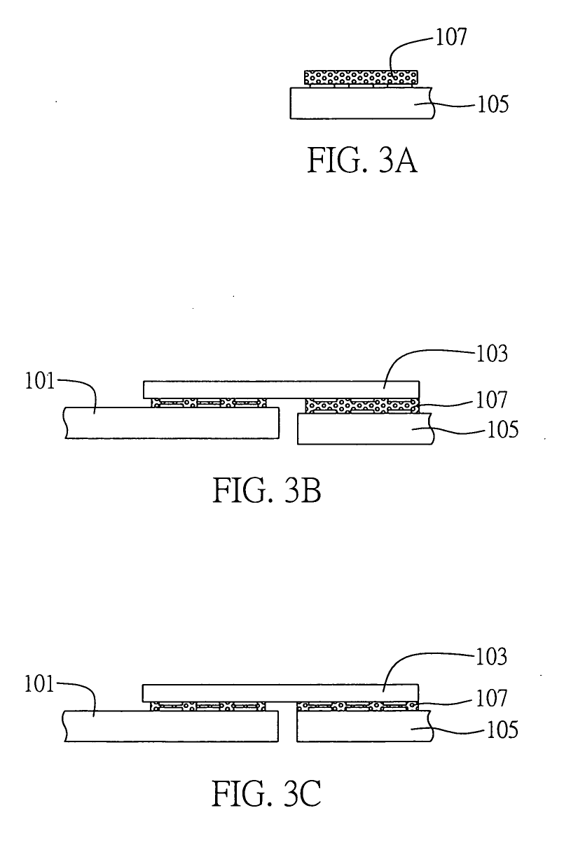

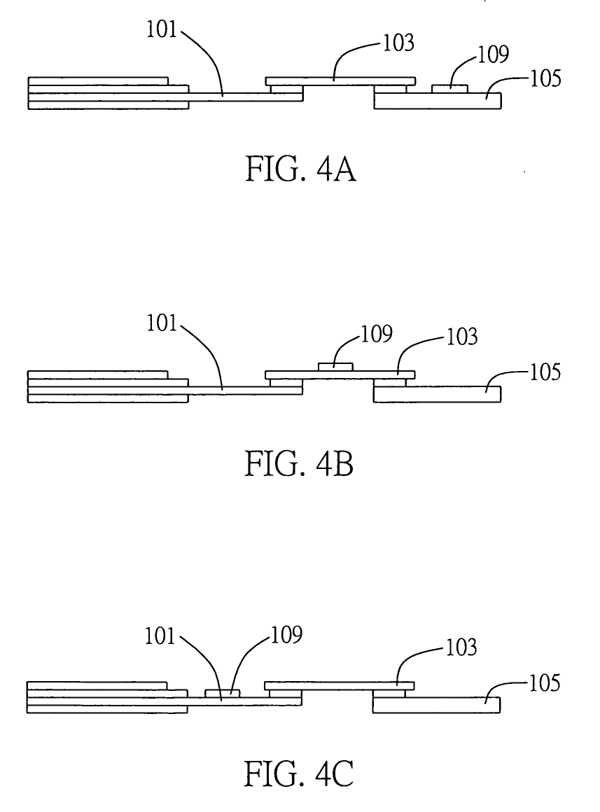

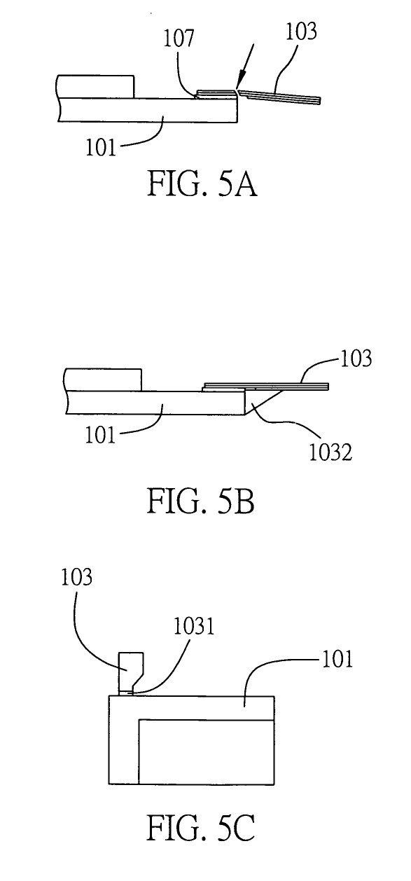

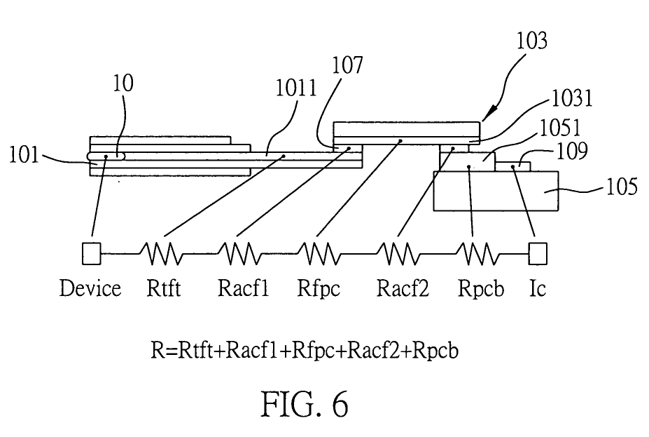

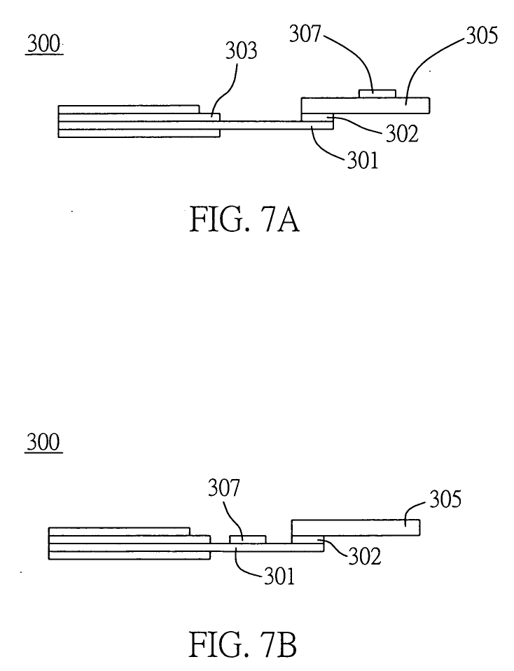

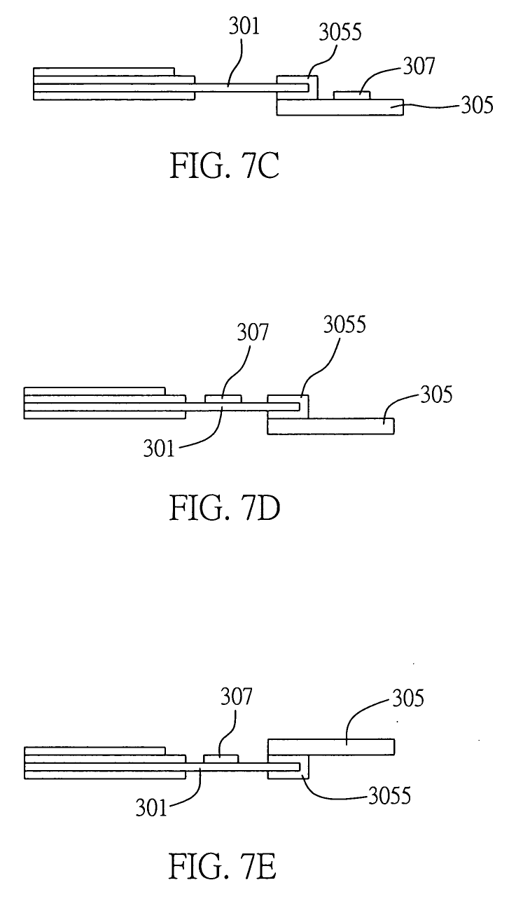

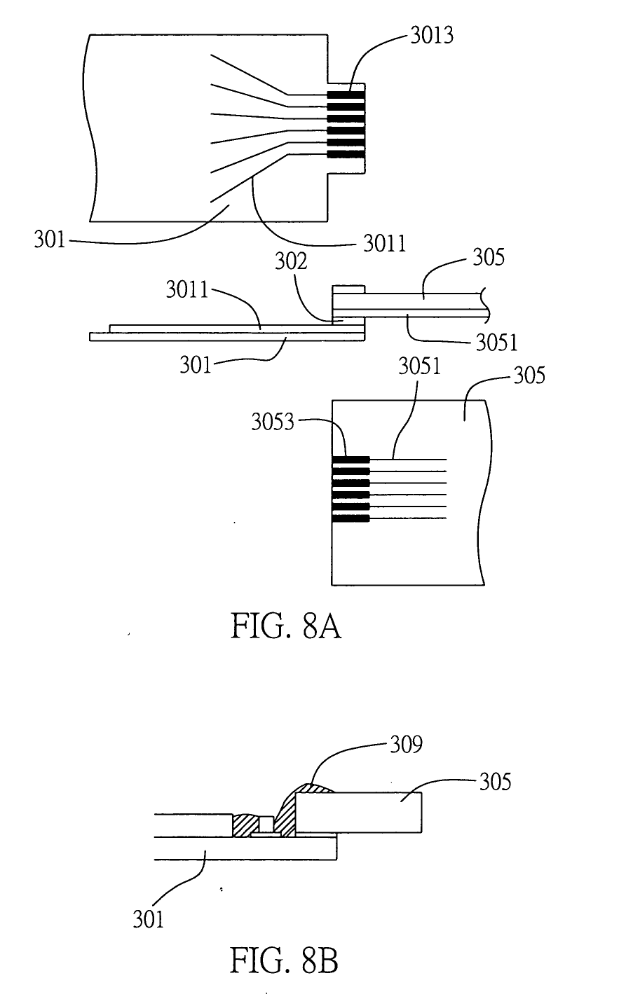

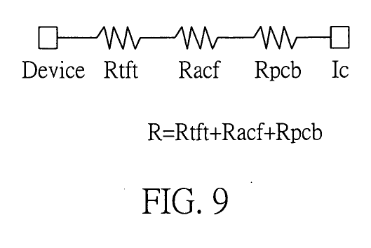

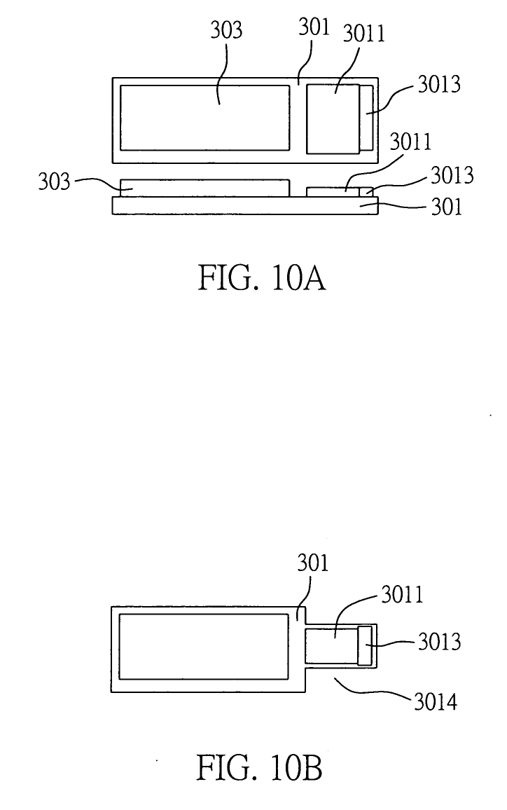

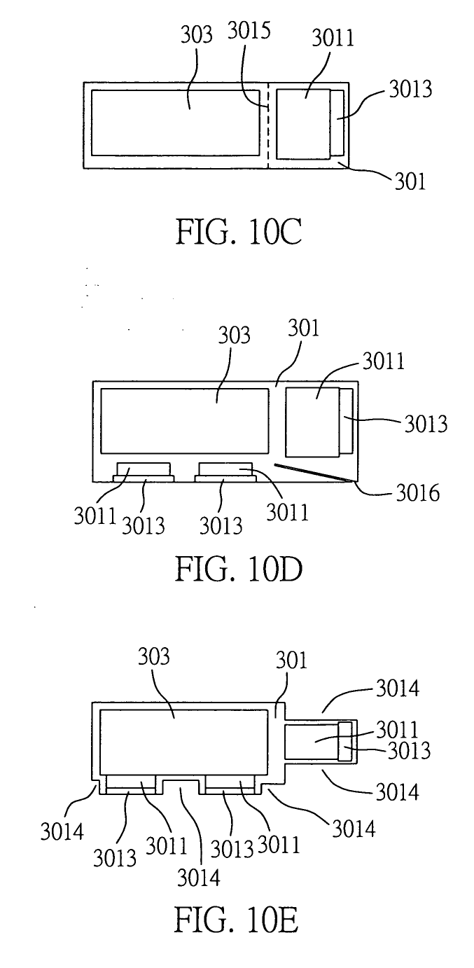

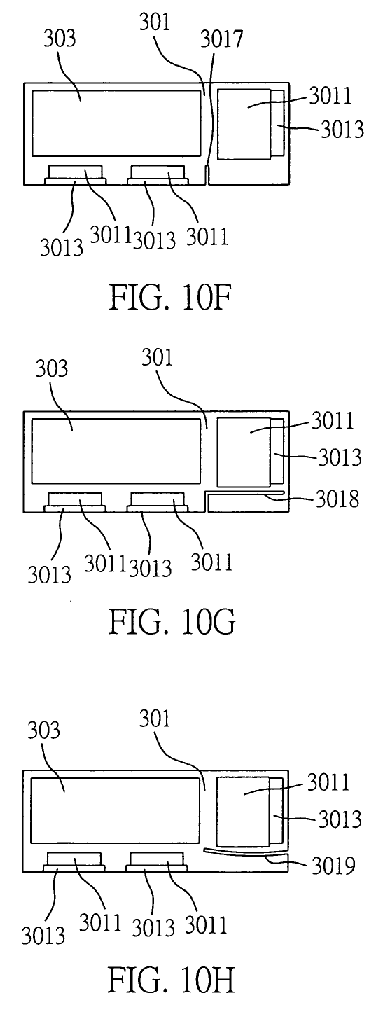

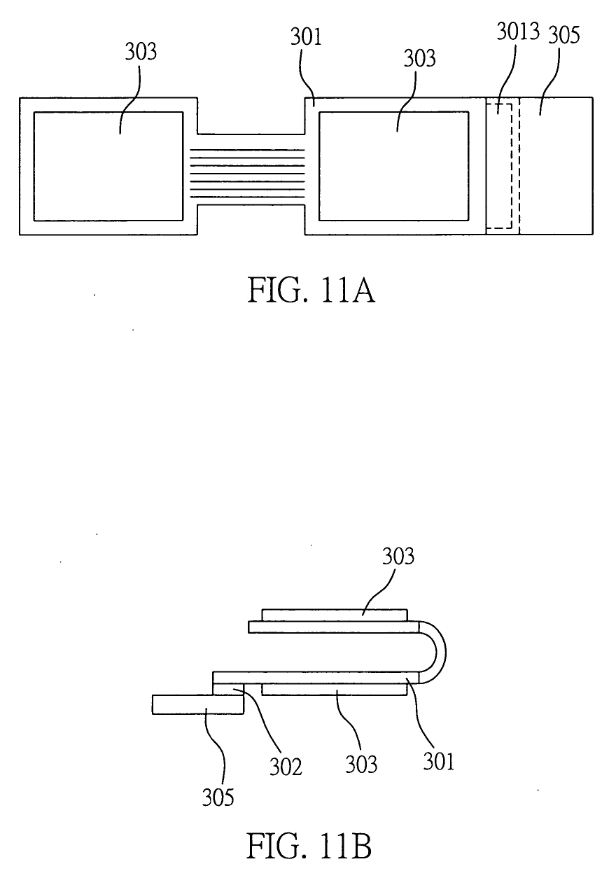

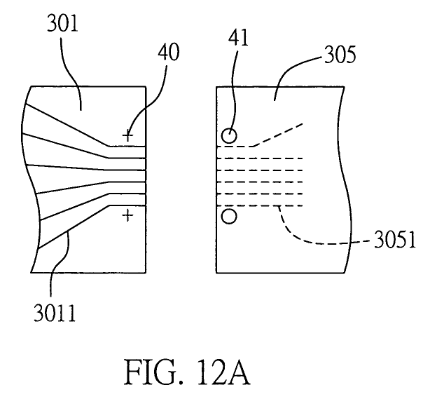

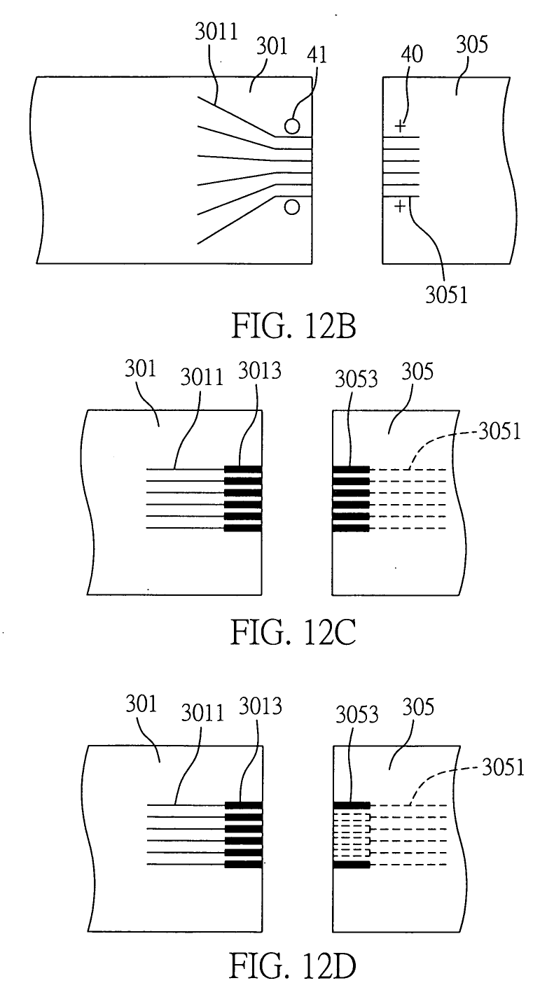

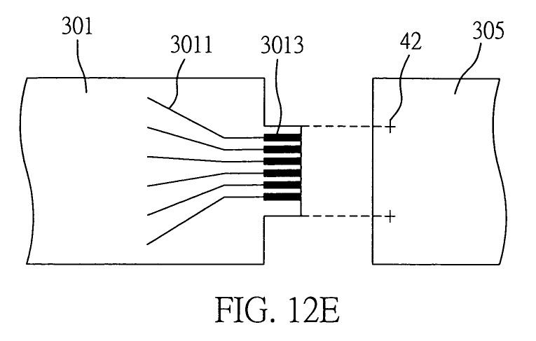

What is claimed is:

1. A display module, comprising:
a display panel having a substrate as a base at least provided with conductive circuits and external connection pins; and
a circuit board electrically connected with the external connection pins of the substrate through a conductive material for driving the display panel.

2. The display module of claim 1, wherein the display panel is a liquid crystal panel.

3. The display module of claim 2, wherein the liquid crystal panel is a TFT (Thin Film Transistor) liquid crystal panel.

4. The display module of claim 1, wherein the display panel further includes at least one upper panel combined with the substrate.

5. The display module of claim 4, wherein the upper panel is a color filter.

6. The display module of claim 4, wherein the upper panel is a protective plate.

7. The display module of claim 1, wherein the substrate is a plastic substrate.

8. The display module of claim 7, wherein the plastic substrate is one of the group consisting of polyether sulfone (PES), polyethylene terephthalate (PET), polyarylate (PAR), cyclic olefin copolymer (COC) and polycarbonate (PC).

9. The display module of claim 1, wherein the substrate is a metallic substrate.

10. The display module of claim 9, wherein the metallic substrate is one of the group consisting of pure Ti, pure Al, Ti alloy, Ti—Mo alloy, Al alloy ,stainless and Al—Mg alloy.

11. The display module of claim 1, wherein the conductive circuits are conductive traces.

12. The display module of claim 1, wherein each of the pins is a pad

13. The display module of claim 1, wherein each of the pins is a finger.

14. The display module of claim 1, wherein each of the pins is a golden finger.

15. The display module of claim 1, wherein the circuit board is a liquid crystal driver.

16. The display module of claim 1, wherein a bending structure is further provided at one side of the substrate corresponding to the conductive circuits.

17. The display module of claim 16, wherein the bending structure includes unfilled corners corresponding to two sides of the conductive circuits on the substrate.

18. The display module of claim 16, wherein the bending structure includes an impression provided on surface of the substrate.

19. The display module of claim 1, wherein conductive circuits are provided at two adjacent sides on surface of the substrate and a cut is formed on the substrate at a corner between the conductive circuits provided at the two adjacent sides.

20. The display module of claim 19, wherein the cut is obliquely formed on the substrate at the corner between the conductive circuits provided at the two adjacent sides.

21. The display module of claim 19, wherein the cut is in an L-shape.

22. The display module of claim 19, wherein the cut is in an arc shape.

23. The display module of claim 19, wherein the cut is transversely formed at one side of the substrate and parallel to the conductive circuits at said side of the substrate.

24. The display module of claim 1, further including a positioning structure to provide a positioning relationship between the substrate and the circuit board.

25. The display module of claim 24, wherein the positioning structure includes marks and positioning holes.

26. The display module of claim 25, wherein the marks are disposed on surface of the substrate and the positioning holes are disposed at corresponding positions on surface of the circuit board.

27. The display module of claim 24, wherein the positioning structure includes conductive circuits disposed on top surface of the circuit board.

28. The display module of claim 24, wherein the positioning structure includes pins disposed on top surface of the circuit board.

29. The display module of claim 28, wherein the positioning structure includes conductive circuits disposed on top surface of the circuit board.

30. The display module of claim 24, wherein the positioning structure includes marks disposed on top surface of the circuit board and corresponding to both edges of the substrate.

31. The display module of claim 30, wherein shape of the marks is one of the group consisting of a straight line, a cross shape and an L-shape.

32. The display module of claim 1, wherein the conductive material is one of the group consisting of TCF, NCF and anisotropic conductive film.

33. The display module of claim 1, further including a plurality of display panels.
